(19) United States
(12) Patent Application Publication
(10) Pub. No.: US 2012/0282060 A1
(43) Pub. Date: Nov. 8, 2012

(54) LOOSE RESISTANT NUT FASTENER

(75) Inventor: Hsiu-Mei Chung, Taichung City (TW)

(73) Assignee: Hsiu-Mei Chung, Taichung City (TW)

(21) Appl. No.: 13/101,423

(22) Filed: May 5, 2011

(51) Int. Cl. F16B 39/30

(52) U.S. Cl. 411/310

(57) ABSTRACT

A loose resistant nut fastener includes a nut body that has a first end face, a second end face opposite to the first end face, a peripheral face connected between the first and second end faces, a threaded hole extending along a first axis and extending from the first end face toward the second end face, an engaging hole that extends from the second end face toward the first end face and that is disposed at one side of the threaded hole, and a slit that extends from the peripheral face toward the first axis and that is disposed between two axially opposite ends of the threaded hole. The nut fastener further includes a tightening component to engage the engaging hole.

### BACKGROUND OF THE INVENTION

1. Field of the Invention

The invention relates to a loose resistant nut fastener, more particularly to a loose resistant nut fastener that includes a tightening component.

2. Description of the Related Art

Nuts and bolts are widely employed to secure various devices. Generally, the nuts have internal threads and the bolts have external threads. The nuts and bolts are fastened together by engaging the internal and external threads. However, the connection between the nut and the bolt is easily loosened due to vibration of the devices.

### SUMMARY OF THE INVENTION

Therefore, the object of the present invention is to provide a loose resistant nut fastener that can overcome the aforesaid drawback of the prior art.

The loose resistant nut fastener according to the present invention comprises a nut body and a tightening component.

The nut body has a first end face, a second end face opposite to the first end face, a peripheral face connected between the first end face and the second end face, a threaded hole extending along a first axis and extending from the first end face toward the second end face, and an engaging hole extending from the second end face toward the first end face, and disposed at one side of the threaded hole. The nut body further has a slit extending from the peripheral face toward the first axis and disposed between two axially opposite ends of the threaded hole. The slit crosses the engaging hole, and configures the nut body into a base part between the first end face and the slit, a bendable part between the second end face and the slit, and a connecting part that is opposite to the slit and that interconnects the bendable part and the base part.

The tightening component is engaged to the engaging hole and is configured to force the bendable part to bend toward the base part and constrict the slit such that deformation of the threaded hole occurs proximate to the bendable part.

### BRIEF DESCRIPTION OF THE DRAWINGS

The above and other features and advantages of the present invention will become apparent in the following detailed description of the preferred embodiment with reference to the accompanying drawings, of which:

FIG. 1 is an exploded perspective view of the preferred embodiment of a loose resistant nut fastener of this invention; and

FIG. 2 is a sectional view illustrating connection of the preferred embodiment shown in FIG. 1 with a bolt.

### DETAILED DESCRIPTION OF THE PREFERRED EMBODIMENT

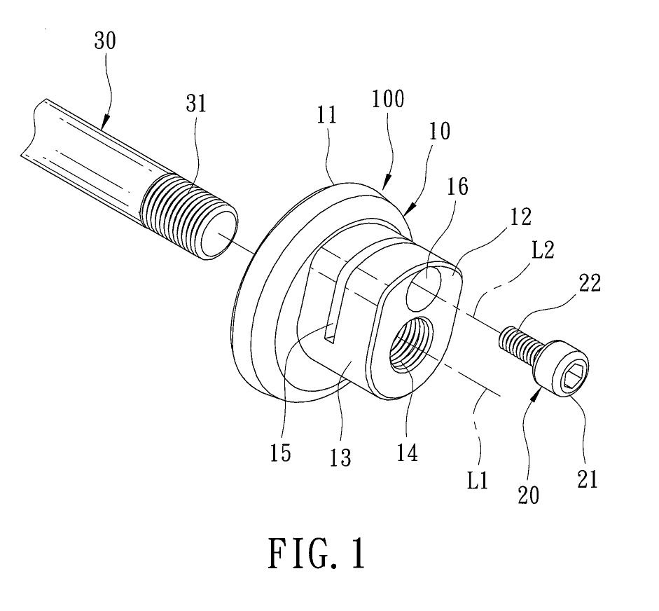

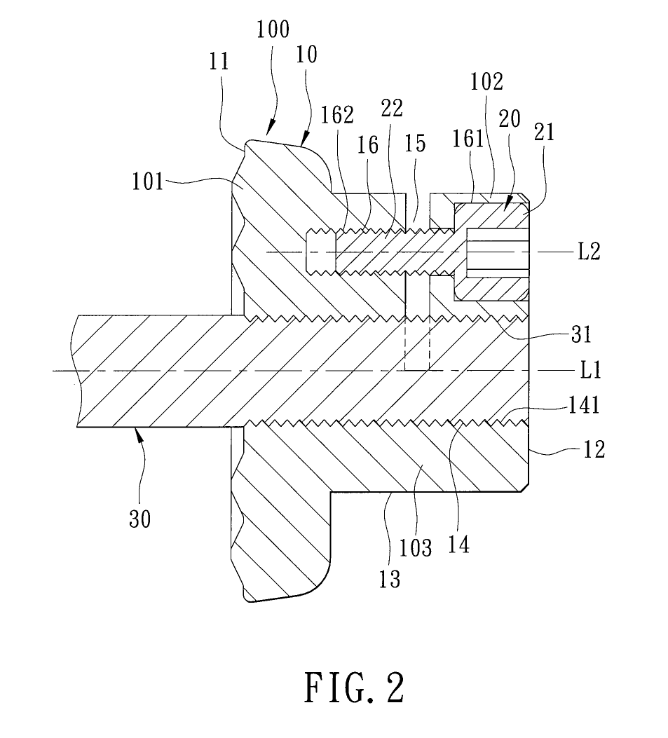

FIGS. 1 and 2 show the preferred embodiment of a loose resistant nut fastener 100 of the present invention that comprises a nut body 10 and a tightening component 20.

The nut body 10 has a first end face 11, a second end face 12 opposite to the first end face 11, a peripheral face 13 connected between the first end face 11 and the second end face 12, a threaded hole 14 having an internal thread 141 and extending from the first end face 11 toward the second end face 12 along a first axis (L1), and an engaging hole 16 extending from the second end face 12 toward the first end face 11 and disposed at one side of the threaded hole 14. The threaded hole 14 extends through the second end face 12 in this embodiment.

The nut body 10 further has a slit 15 that extends from the peripheral face 13 toward the first axis (L1) and that is disposed between two axially opposite ends of the threaded hole 14. The slit 15 crosses the engaging hole 16, and configures the nut body 10 into a base part 101 between the first end face 11 and the slit 15, a bendable part 102 between the second end face 12 and the slit 15, and a connecting part 103 that is opposite to the slit 15 and that interconnects the bendable part 102 and the base part 101. In this embodiment, the slit 15 extends into and is in spatial communication with the threaded hole 14, and is substantially transverse to the first axis (L1). However, the slit 15 may be configured differently in other embodiments of the invention.

The engaging hole 16 includes a counterbore segment 161 formed in the bendable part 102, and a threaded segment 162 formed in the base part 101. In this embodiment, the engaging hole 16 extends along a second axis (L2) that is substantially parallel to the first axis (L1).

The tightening component 20 is engaged to the engaging hole 16, and has a head portion 21 that is received in the counterbore segment 161, and a threaded shank portion 22 that engages the threaded segment 162.

The bolt 30 has an external thread 31 and is capable of engaging the internal thread 141 of the threaded hole 14. When the bolt 30 is engaged to the threaded hole 14 and the tightening component 20 is engaged to the engaging hole 16, the tightening component 20 forces the bendable part 102 to bend toward the base part 101 and constrict the slit 15, such that deformation of the threaded hole 14 occurs proximate to the bendable part 102, thereby enhancing the engagement between the internal thread 141 of the threaded hole 14 and the external thread 31 of the bolt 30 such that the nut fastener 100 is resistant to loosening from the bolt 30 even when subjected to vibrations.

When the bolt 30 is to be separated from the loose resistant nut fastener 100 of this invention, the tightening component 20 has to be firstly loosened to release the force between the bolt 30 and the threaded hole 14 attributed to bending of the bendable part 102 so that the bolt 30 may be easily removed.

By virtue of the tightening component 20, the loose resistant nut fastener 100 of this invention is securely fastened to the bolt 30, thereby preventing loosening problem due to vibrations and improving safety of a device that incorporates the loose resistant nut fastener 100 of this invention.

While the present invention has been described in connection with what is considered the most practical and preferred embodiment, it is understood that this invention is not limited to the disclosed embodiment but is intended to cover various arrangements included within the spirit and scope of the broadest interpretation and equivalent arrangements.

What is claimed is:

1. A loose resistant nut fastener, comprising:
a nut body having a first end face, a second end face opposite to said first end face, a peripheral face connected between said first end face and said second end face, a threaded hole extending along a first axis and extending from said first end face toward said second end face, and an engaging hole extending from said second end face toward said first end face, and disposed at one side of said threaded hole, said nut body further having a slit extending from said peripheral face toward the first axis and disposed between two axially opposite ends of said threaded hole, said slit crossing said engaging hole, and configuring said nut body into a base part between said first end face and said slit, a bendable part between said second end face and said slit, and a connecting part that is opposite to said slit and that interconnects said bendable part and said base part; and
a tightening component engaged to said engaging hole and configured to force said bendable part to bend toward said base part and constrict said slit such that deformation of said threaded hole occurs proximate to said bendable part.

2. The loose resistant nut fastener as claimed in claim 1, wherein said slit extends to and is in spatial communication with said threaded hole.

3. The loose resistant nut fastener as claimed in claim 1, wherein said engaging hole includes a counterbore segment formed in said bendable part, and a threaded segment formed in said base part.

4. The loose resistant nut fastener as claimed in claim 1, wherein said slit extends substantially transverse to the first axis.

5. The loose resistant nut fastener as claimed in claim 1, wherein said engaging hole extends along a second axis that is substantially parallel to the first axis.

6. The loose resistant nut fastener as claimed in claim 2, wherein said engaging hole includes a counterbore segment formed in said bendable part, and a threaded segment formed in said base part.

7. The loose resistant nut fastener as claimed in claim 6, wherein said slit extends substantially transverse to the first axis.

8. The loose resistant nut fastener as claimed in claim 7, wherein said engaging hole extends along a second axis that is substantially parallel to the first axis.
